(19) United States
(12) Patent Application Publication
(10) Pub. No.: US 2007/0216969 A1
(43) Pub. Date: Sep. 20, 2007

(54) IMAGE READING APPARATUS AND IMAGE FORMING APPARATUS

(76) Inventor: Kiichiro NISHINA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/678,895

(22) Filed: Feb. 26, 2007

(30) Foreign Application Priority Data
Mar. 20, 2006 (JP) 2006-077569

(51) Int. Cl. H04N 1/04

(52) U.S. Cl. 358/509; 358/474

(57) ABSTRACT

An image reading apparatus includes: a document placement glass; an illumination system configured to illuminate the document; an image forming optical system configured to image reflected light of the document; a sensor configured to perform photoelectric conversion of an image of the document; and a controller configured to move the illumination system and the image forming optical system to scan and read the document with a state in which the document is fixed onto the document placement glass as a first document reading type, configured to read the document while moving the document with a state in which the illumination system and the image forming optical system are fixed as a second document reading type, and configured to change an object distance from a document placement surface of the document placement glass to an image forming element of the image forming optical system when the document is to be read by the first document reading type and when the document is to be read by the second document reading type.

### BACKGROUND

The present invention relates to an image reading apparatus used in a copying machine, a facsimile and so on, and to an image forming apparatus.

An image reading apparatus used as a document reading section of a facsimile, a digital copying machine and so on images reflected light of a document illuminated by an illumination system onto a line sensor, which carries out photoelectric conversion, by an image forming optical system so as to convert image information of the document to a signal.

Some of the image reading apparatuses have a type by which the document is read by placing the document on a document placement glass, pressing the document with a document pressing plate, and scanning the document with the illumination system and the image forming optical system (hereinafter simply referred to as a “pressure plate type”), and a type by which the document is read by conveying the document with an automatic document feeder, which automatically feeds a sheet of document on the document placement glass as an exposure position of an optical system, without moving the illumination system and the image forming optical system, in order for promoting efficiency in reading operation of the sheet of document (hereinafter simply referred to as a “sheet-through type”). Note that the document pressing plate and the automatic document feeder will be hereinafter referred to as a “pressure plate” and “ADF”, respectively, for the purpose of simplicity.

In the image reading apparatus having the pressure plate type and the sheet-through type for reading the document, it is possible to set the document on the document placement glass in a relatively close-contact state when the document is read by the pressure plate type. On the other hand, in a case of the sheet-through type, so-called document-floating in which an interspace between the document placement glass and the document occurs is generated, since there is necessity of conveying the document in such a manner that the document passes on the document placement glass. Thus, there is a problem in the sheet-through type that out-of-focus occurs by the interspace generated by the document-floating, and thereby, image quality in reading of the document is degraded.

In addition, in an image reading apparatus which converts colored image information of the document to a signal by: utilizing a so-called three-line CCD (Charge-Coupled Device), in which a line sensor having a red filter, a line sensor having a green filter, and a line sensor having a blue filter for example are aligned in a single chip; imaging an image of the document on a light-receiving surface of the three-line CCD; and carrying out color separation of the image of the document into three primary light colors so as to read information of the document in color, a balance of colors among red, green, and blue becomes imbalanced due to the document-floating caused in the sheet-through type. Hence, problems such as deterioration in color-reproducibility, coloring of a thin line and so on occur.

As one measure to solve such problems, the invention described in Japanese patent publication No. 2004-247998 is known. The invention disclosed in JP2004-247998A shifts a focus adjustment position in whole by around 0.5 mm, such that it does not become out-of-focus in the extreme even when the document is conveyed with the sheet-through type.

However, the measure according to the invention disclosed in JP2004-247998A, although it has an advantage in that performance at the time of the pressure plate type and performance at the time of the sheet-through type can be averaged, has a drawback that high performance cannot be ensured in both of the pressure plate type and the sheet-through type, since the most appropriate focus is not obtained in both types.

### SUMMARY

At least one objective of the present invention is to provide an image reading apparatus capable of reading a document with an optimum state in both of the types of the pressure plate type and the sheet-through type, and an image forming apparatus having the image reading apparatus.

To achieve these and other advantages and in accordance with the purpose of the invention, as embodied and broadly described herein, the invention provides an image reading apparatus, comprising: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, configured to read the document while moving the document with a state in which the illumination system and the image forming optical system are fixed as a second document reading type, and configured to change an object distance from the document placement surface of the document placement glass to the image forming element of the image forming optical system when the document is to be read by the first document reading type and when the document is to be read by the second document reading type.

Advantageously, the controller is configured to move the document in the second document reading type by utilizing an automatic document feeder.

Advantageously, the image forming element structuring the image forming optical system includes an image forming lens configured to perform reduction-image formation of the image of the document.

Advantageously, the image reading apparatus further comprises: a first moving carriage having at least one reflection mirror and the illumination system; and a second moving carriage having at least two reflection mirrors, wherein the controller is configured to move the first moving carriage and the second moving carriage to scan the document surface of the document at a speed ratio of 2:1 in the first document reading type.

Advantageously, the image reading apparatus further comprises an integrated optical system having at least one reflection mirror, the image forming element and the sensor, and wherein the controller is configured to move the integrated optical system and the illumination system in the first document reading type.

Advantageously, the image forming element of the image forming optical system includes an unit-magnification image forming element.

Advantageously, the image reading apparatus further comprises: a first moving carriage having at least one reflection mirror and the illumination system; and a second moving carriage having at least two reflection mirrors, wherein the controller is configured to vary a distance between the first moving carriage and the second moving carriage to change the object distance from the document placement surface of the document placement glass to the image forming element of the image forming optical system in the first document reading type and the second document reading type.

Advantageously, the image forming element structuring the image forming optical system includes an image forming lens configured to perform reduction-image formation of the image of the document, and wherein the controller is configured to vary a position of the image forming lens and the sensor integrally to change the object distance from the document placement surface of the document placement glass to the image forming element of the image forming optical system in the first document reading type and the second document reading type.

Advantageously, the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

Advantageously, the image reading apparatus further comprises a color separation element disposed in an optical path of the image forming optical system, such that information of the document is read in color.

Advantageously, the controller is configured to detect whether the document is to be read by the first document reading type or the second document reading type, and configured to determine the object distance from the document placement surface of the document placement glass to the image forming element of the image forming optical system based on a result of the detection.

In addition, the invention provides an image forming apparatus, comprising an image reading apparatus including: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, configured to read the document while moving the document with a state in which the illumination system and the image forming optical system are fixed as a second document reading type, and configured to change an object distance from the document placement surface of the document placement glass to the image forming element of the image forming optical system when the document is to be read by the first document reading type and when the document is to be read by the second document reading type.

Furthermore, the invention provides an image reading apparatus, comprising: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type, wherein the document placement glass includes a first document placement glass used in the first document reading type and having a first thickness, and a second document placement glass used in the second document reading type and having a second thickness different from the first thickness of the first document placement glass to vary an optical distance, such that an object distance from the document placement surface of the document placement glass to the image forming element of the image forming optical system when the document is to be read by the first document reading type and when the document is to be read by the second document reading type is changed.

Moreover, the invention provides an image reading apparatus, comprising: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type, wherein the document placement glass includes a first document placement glass used in the first document reading type and having a first refractive index, and a second document placement glass used in the second document reading type and having a second refractive index different from the first refractive index of the first document placement glass to vary an optical distance, such that an object distance from the document placement surface of the document placement glass to the image forming element of the image forming optical system when the document is to be read by the first document reading type and when the document is to be read by the second document reading type is changed.

Advantageously, the second document placement glass further includes a refractive index different from a refractive index of the first document placement glass to change the optical distance, such that the object distance from the document placement surface of the document placement glass to the image forming element of the image forming optical system when the document is to be read by the first document reading type and when the document is to be read by the second document reading type is changed.

Advantageously, the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

Advantageously, the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

Advantageously, the image reading apparatus further comprises a color separation element disposed in an optical path of the image forming optical system, such that information of the document is read in color.

Advantageously, the image reading apparatus further comprises a color separation element disposed in an optical path of the image forming optical system, such that information of the document is read in color.

Advantageously, the controller is configured to detect whether the document is to be read by the first document reading type or the second document reading type, and configured to determine the object distance from the document placement surface of the document placement glass to the image forming element of the image forming optical system based on a result of the detection.

Advantageously, the controller is configured to detect whether the document is to be read by the first document reading type or the second document reading type, and configured to determine the object distance from the document placement surface of the document placement glass to the image forming element of the image forming optical system based on a result of the detection.

Also, the invention provides an image forming apparatus, comprising an image reading apparatus including: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type, wherein the document placement glass includes a first document placement glass used in the first document reading type and having a first thickness, and a second document placement glass used in the second document reading type and having a second thickness different from the first thickness of the first document placement glass to vary an optical distance, such that an object distance from the document placement surface of the document placement glass to the image forming element of the image forming optical system when the document is to be read by the first document reading type and when the document is to be read by the second document reading type is changed.

In addition, the invention provides an image forming apparatus, comprising an image reading apparatus including: a document placement glass having a document placement surface and on which a document is placed; an illumination system configured to illuminate the document; an image forming optical system including an image forming element and configured to image reflected light of the document illuminated by the illumination system; a sensor configured to perform photoelectric conversion of an image of the document imaged by the image forming optical system; and a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type, wherein the document placement glass includes a first document placement glass used in the first document reading type and having a first refractive index, and a second document placement glass used in the second document reading type and having a second refractive index different from the first refractive index of the first document placement glass to vary an optical distance, such that an object distance from the document placement surface of the document placement glass to the image forming element of the image forming optical system when the document is to be read by the first document reading type and when the document is to be read by the second document reading type is changed.

Advantageously, the second document placement glass further includes a refractive index different from a refractive index of the first document placement glass to vary the optical distance, such that the object distance from the document placement surface of the document placement glass to the image forming element of the image forming optical system when the document is to be read by the first document reading type and when the document is to be read by the second document reading type is changed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram schematically illustrating an image reading apparatus according to a first embodiment of the present invention.

FIG. 2 is a diagram schematically illustrating an example of operation when a document is read by the image reading apparatus illustrated in FIG. 1 with the pressure plate type.

FIG. 3 is a diagram schematically illustrating an example of operation when the document is read by the image reading apparatus illustrated in FIG. 1 with the sheet-through type.

FIG. 4 is a diagram schematically illustrating an image reading apparatus according to a second embodiment of the present invention.

FIG. 5 is a diagram schematically illustrating an example of operation when the document is read by the image reading apparatus illustrated in FIG. 4 with the pressure plate type.

FIG. 6 is a diagram schematically illustrating an image reading apparatus according to a third embodiment of the present invention.

FIG. 7 is a diagram schematically illustrating an example of operation when the document is read by the image reading apparatus illustrated in FIG. 6 with the pressure plate type.

FIG. 8 is a diagram schematically illustrating an image reading apparatus according to a fourth embodiment of the present invention.

FIG. 9 is a diagram schematically illustrating an image reading apparatus according to a fifth embodiment of the present invention.

FIG. 10 is a diagram schematically illustrating an image reading apparatus according to a sixth embodiment of the present invention.

FIG. 11 is a diagram schematically illustrating an image reading apparatus according to a seventh embodiment of the present invention.

FIG. 12 is a diagram schematically illustrating an example of operation when the document is read by the image reading apparatus illustrated in FIG. 11 with the pressure plate type.

FIG. 13 is a diagram schematically illustrating an image reading apparatus according to an eighth embodiment of the present invention.

FIG. 14 is a diagram schematically illustrating an example of operation when the document is read by the image reading apparatus illustrated in FIG. 13 with the pressure plate type.

FIG. 15 is a diagram schematically illustrating an image reading apparatus according to a ninth embodiment of the present invention.

FIG. 16 is a diagram schematically illustrating an image reading apparatus according to a tenth embodiment of the present invention.

FIG. 17 is a diagram schematically illustrating an image reading apparatus according to an eleventh embodiment of the present invention.

FIG. 18 is a diagram schematically illustrating an image forming apparatus according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. The scope of the present invention, however, is not limited to these embodiments. Within the scope of the present invention, any structure and material described below can be appropriately modified.

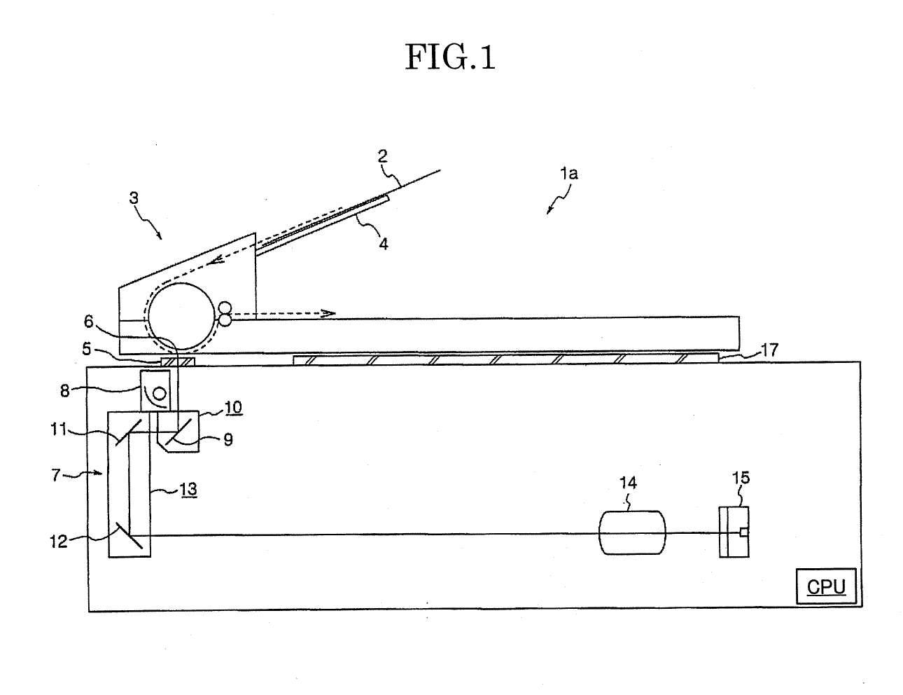

First, an image reading apparatus according to a first embodiment of the present invention, in which an optical system having three mirrors and a reduction image forming lens is provided, will be described with referring to FIGS. 1 to 3.

In an image reading apparatus 1a according to the first embodiment, when a document 2 is to be read with the sheet-through type or a second document reading type, the document 2 is conveyed from a document tray 4 of ADF 3 to a document placement glass 5 being dedicated for the sheet-through type, and the document 2 is conveyed to pass a document reading position 6 on the document placement glass 5 at a substantially constant speed. Then, document information of the conveyed document 2 is read by an optical system 7 preferably stopped substantially beneath the document reading position 6. Note that control for each object to be controlled such as the optical system 7, a conveying system of the document 2 and so on for example is realized by a controller or CPU (Central Processing Unit) according to a predetermined program stored in a programmable memory.

The optical system 7 includes a first traveling body or a first moving carriage 10 by which an illumination system 8 and a first mirror 9 are integrally moveable, and a second traveling body or a second moving carriage 13 having a second mirror 11 and a third mirror 12. The document 2 conveyed by the ADF 3 is illuminated by the illumination system 8, and reflected light or image light of the document 2 is reflected by the first mirror 9 of the first moving carriage 10. Thereafter, the reflected light of the document 2 is subsequently reflected by the second mirror 11 and the third mirror 12 of the second moving carriage 13, and the subsequently reflected light is then guided toward a reduction image forming lens 14 to be imaged on a line sensor 15, and thereby, the document information is read by the optical system 7.

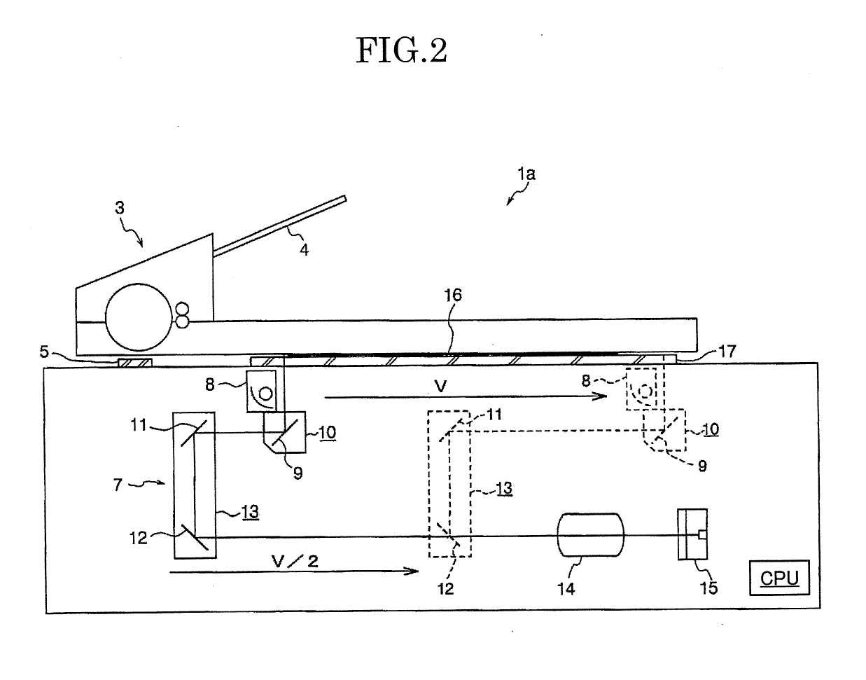

Referring to FIG. 2, when a document 16 is to be read with the pressure plate type or a first document reading type, the document 16 is arranged on a document placement glass 17, and the first moving carriage 10 and the second moving carriage 13 move to their reading initiation positions of the pressure plate type, respectively. Then, the document 16 is illuminated by the illumination system 8, and reflected light of the illuminated document 16 is reflected by the first mirror 9 of the first moving carriage 10. Thereafter, the reflected light is subsequently reflected by the second mirror 11 and the third mirror 12 of the second moving carriage 13, and the subsequently reflected light is then guided toward the reduction image forming lens 14 to be imaged on the line sensor 15. In this state, when the document 16 is read in a longitudinal direction thereof, the first moving carriage 10 moves to a position illustrated by a dotted line at a speed of “V”, while simultaneously the second moving carriage 13 moves to a position illustrated by a dotted line at a speed “V/2” half the speed of the first moving carriage 10, so as to read the entire part of the document 16.

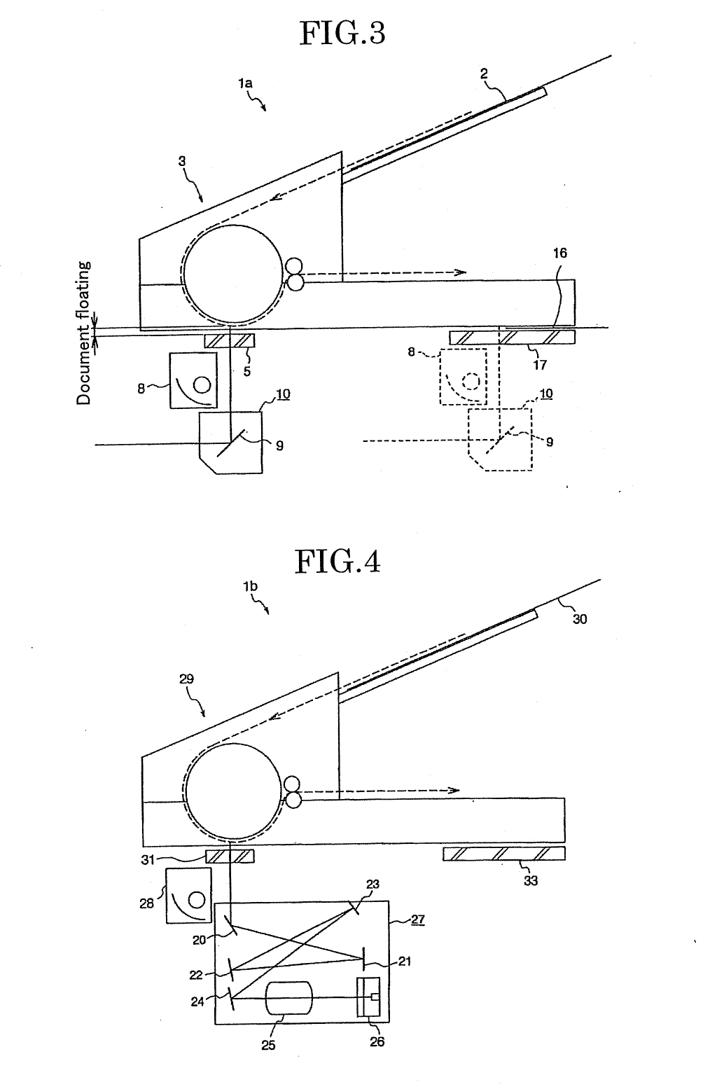

As illustrated in FIG. 3, in the image reading apparatus 1a according to the first embodiment, an object distance (or a distance from a surface of the document placement glass 5 facing a side of the document, i.e. a document surface side, to the reduction image forming lens 14 on the document surface side for example) used when the document 2 is read with the sheet-through type as illustrated by a solid line is set to be shorter than an object distance (or a distance from the document surface side of the document placement glass 17 to the reduction image forming lens 14 on the document surface side for example) used when the document 16 is read with the pressure plate type as illustrated by a dotted line, such that out-of-focus is not generated even when the document-floating is occurred by the interspace between the document 2, conveyed without being in close-contact with the document placement glass 5, and the document placement glass 5 in a case in which the document 2 is read by the sheet-through type.

Therefore, according to the first embodiment of the invention, the object distance in the sheet-through type is adjusted to be shorter when the object distance is set such that the focus becomes optimum in the pressure plate type in which the document-floating does not generate. Conversely, when the object distance is set such that the focus becomes optimum in the sheet-through type, the object distance in the pressure plate type is adjusted to be longer. Hence, it is possible to obtain fine reading quality when the document 2 is read by the sheet-through type and also when the document 16 is read by the pressure plate type.

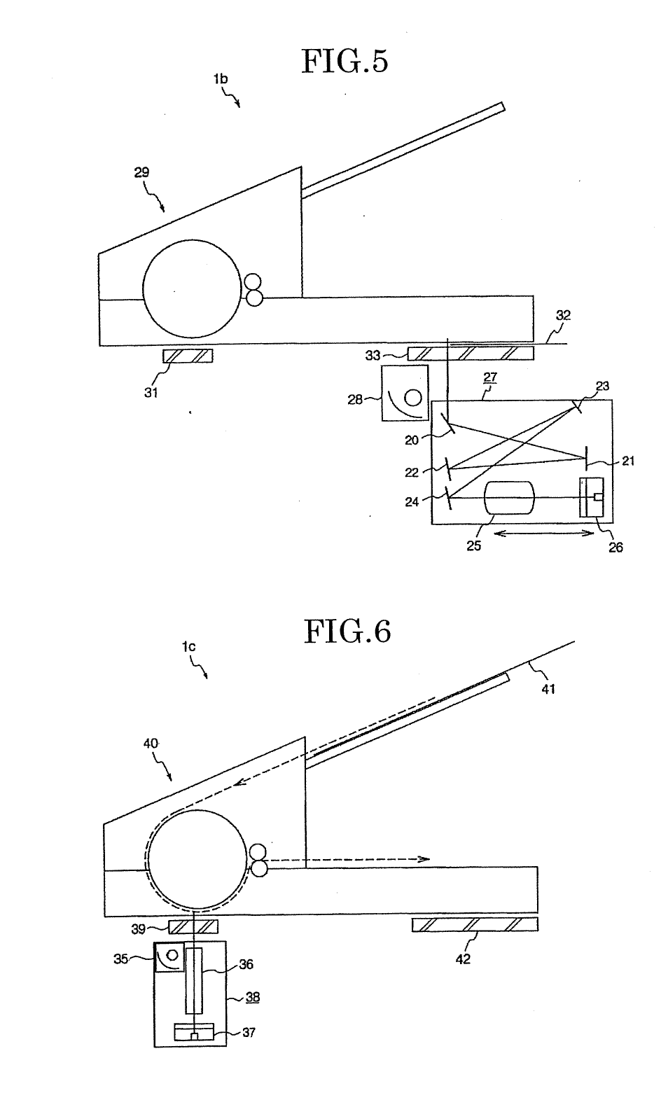

Next, an image reading apparatus according to a second embodiment of the present invention having five mirrors will be described with referring to FIGS. 4 and 5.

In an image reading apparatus 1b according to the second embodiment, an integrated optical system 27 in which five mirrors 20-24, a reduction image forming lens 25 and a line sensor 26 are provided integrally, and an illumination system 28 are moved to change a reading type from the sheet-through type to the pressure plate type and vice versa.

In the sheet-through type, the illumination system 28 and the integrated optical system 27 are stopped at positions corresponding to a document placement glass 31 as illustrated in FIG. 4, respectively. A document 30 conveyed by ADF 29 is illuminated by the illumination system 28, and reflected light of the conveyed document 30 is subsequently reflected by the five mirrors 20-24. Thereafter, the subsequently reflected light is guided toward the reduction image forming lens 25 to be imaged on the line sensor 26 so as to read document information of the document 30.

In the pressure plate type, the optical system 28 and the integrated optical system 27 are moved to positions corresponding to a document placement glass 33 as illustrated in FIG. 5, respectively, to scan a document 32 placed on the document placement glass 33 so as to read document information thereof.

At this time, when a position of each of the mirrors 20-24 is adjusted to set an object distance such that focus becomes optimum in the pressure plate type in which the document-floating does not generate for example, the position of each of the mirrors 20-24 is adjusted to shorten the object distance when a document 30 is to be read by the sheet-through type. On the other hand, when the focus is adjusted to be optimum in the sheet-through type, the position of each of the mirrors 20-24 is adjusted such that the object distance in the pressure plate type becomes longer in a case in which the document 32 is to be read by the pressure plate type.

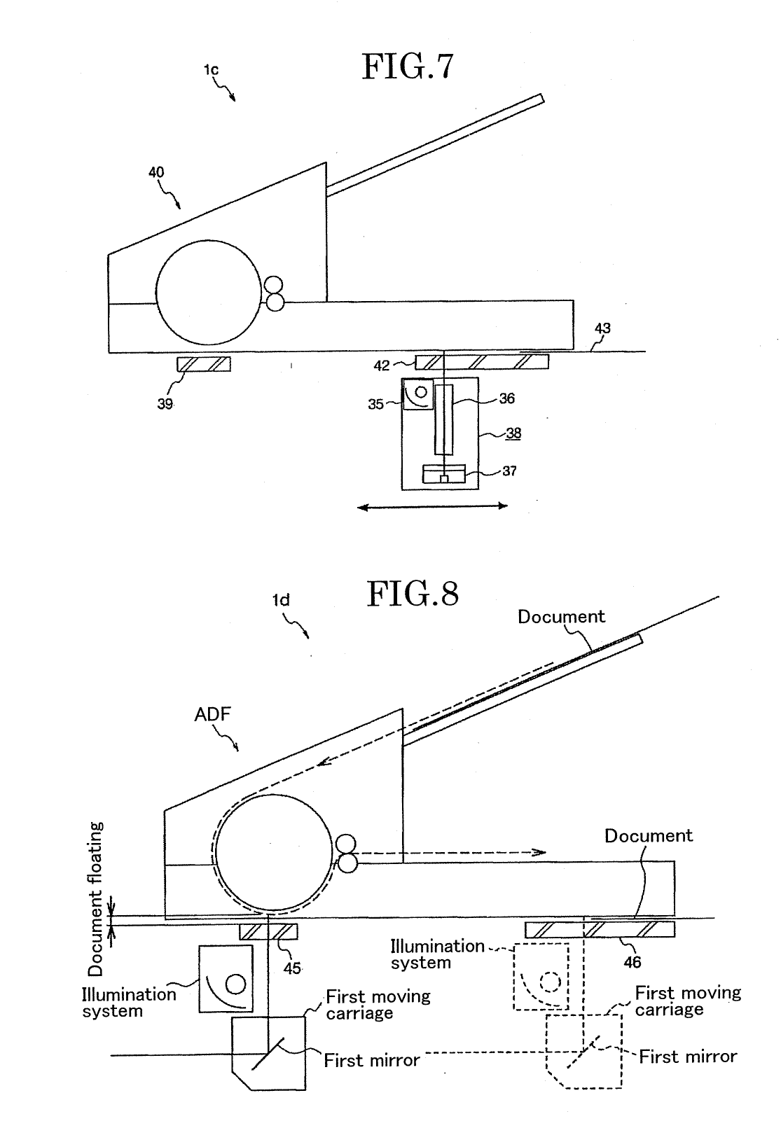

Next, an image reading apparatus according to a third embodiment of the present invention, in which an equal-magnification image forming element or an unit-magnification image forming element is provided, will be described with referring to FIGS. 6 and 7.

In an image reading apparatus 1c illustrated in FIG. 6, in a case of the sheet-through type, an optical system 38 having an illumination system 35, an unit-magnification image forming element 36, and an unit-magnification sensor 37 is stopped at a position corresponding to a document placement glass 39. In the stopped state of the optical system 38, an image of a document 41 conveyed by ADF 40 is imaged with the unit-magnification image forming element 36 on the unit-magnification sensor 37 while the conveyed document 41 is illuminated by the illumination system 35, to read document information of the document 41.

In a case of the pressure plate type, the optical system 38 is moved to a position corresponding to a document placement glass 42 as illustrated in FIG. 7, and thereafter, the optical system 38 is made to scan a document 43 placed on the document placement glass 42, to read information of the document 43.

At this time, when a position of the unit-magnification image forming element 36 is adjusted to set an object distance such that focus becomes optimum in the pressure plate type in which the document-floating does not generate for example, the position of the unit-magnification image forming element 36 is adjusted to shorten the object distance when the document 41 is to be read by the sheet-through type. Conversely, when the focus is adjusted to be optimum in the sheet-through type, the position of the unit-magnification image forming element 36 is adjusted such that the object distance in the pressure plate type becomes longer in a case when the document 42 is to be read by the pressure plate type.

Next, an image reading apparatus according to a fourth embodiment of the present invention, which changes an object distance by varying thickness of each document placement glass to change an optical distance, will be described with referring to FIG. 8.

In an image reading apparatus 1d illustrated in FIG. 8, thickness of a document placement glass 45 used in the sheet-through type and thickness of a document placement glass 46 used in the pressure plate type are varied from each other to change the optical distance.

More specifically, when light enters a parallel plate such as the document placement glasses 45 and 46, the optical distance is floated or lifted due to the thickness of the parallel plate and its refractive index, as represented by a following formula (1):

Δt=(n−1)/n×d (1)

where Δt is an amount of lifting of the optical distance, n is the refractive index of the parallel plate, and d is the thickness of the parallel plate.

For example, when the thickness of the document placement glass 46 in the pressure plate type is 3 mm and the refractive index thereof is 1.5, the amount of lifting of the optical distance Δt according to the formula (1) is:

Δt=(1.5−1)/1.5×3=1 mm

Accordingly, when the refractive index of the document placement glass 45 for the sheet-through type is provided to be same as that of the document placement glass 46 while the thickness of the document placement glass 45 is set to be in 5 mm, the amount of lifting of the optical distance Δt is:

Δt=(1.5−1)/1.5×5=1.67 mm

Hence, the document surface side of the document placement glass 45 used for the sheet-through type becomes optically closer to a conveyed document by 0.67 mm for example. As a result, it is possible to ensure an image forming state similar to that of the pressure plate type even when the document-floating of about 0.67 mm is generated in the sheet-through type.

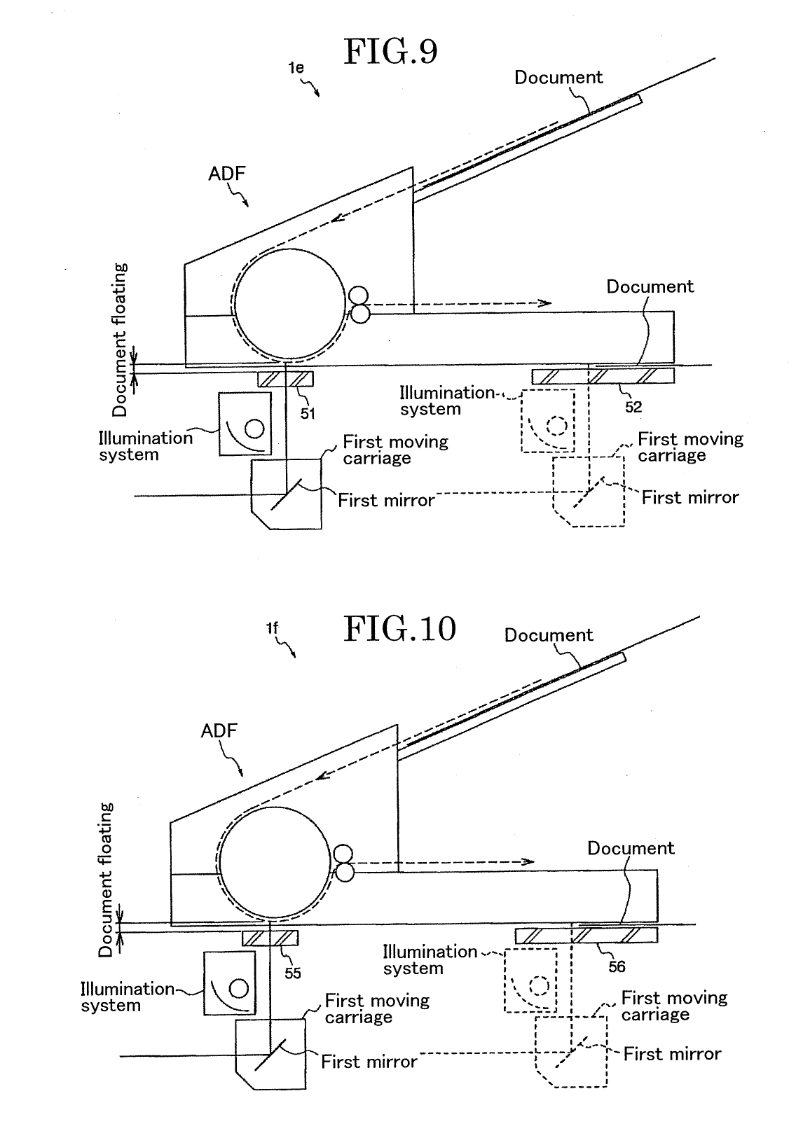

Next, an image reading apparatus according to a fifth embodiment of the present invention, which changes an object distance by varying a refractive index of each document placement glass to change an optical distance, will be described with referring to FIG. 9.

In an image reading apparatus 1e illustrated in FIG. 9, a refractive index of a document placement glass 51 used in the sheet-through type and a refractive index of a document placement glass 52 used in the pressure plate type are varied from each other to change the optical distance.

For example, when thickness of the document placement glass 52 used for the sheet-through type is 3 mm, the refractive index thereof is 1.5, and when the amount of lifting of the optical distance Δt is calculated by utilizing the formula (1), the following is obtained:

Δt=(1.5−1)/1.5×3=1 mm

In addition, when the refractive index of the document placement glass 51 used for the sheet-through type is 2.0 and the thickness thereof is provided to be in 3 mm same as that of the document placement glass 52, the amount of lifting of the optical distance Δt is:

Δt=(2.0−1)/2.0×3=1.5 mm

Hence, the document surface side of the document placement glass 51 used for the sheet-through type becomes optically closer to a conveyed document by 0.5 mm for example. Therefore, it is possible to ensure an image forming state similar to that of the pressure plate type even when the document-floating of about 0.5 mm is generated in the sheet-through type.

Next, an image reading apparatus according to a sixth embodiment of the present invention, which changes an object distance by varying thickness and a refractive index of each document placement glass to change an optical distance, will be described with referring to FIG. 10.

In an image reading apparatus 1f illustrated in FIG. 10, thickness and a refractive index of a document placement glass 55 used in the sheet-through type, and thickness and a refractive index of a document placement glass 56 used in the pressure plate type, are varied from each other to change the optical distance.

According to the present embodiment, it is possible to compensate the document-floating in the sheet-through type, as obvious from the fourth and the fifth embodiments described above.

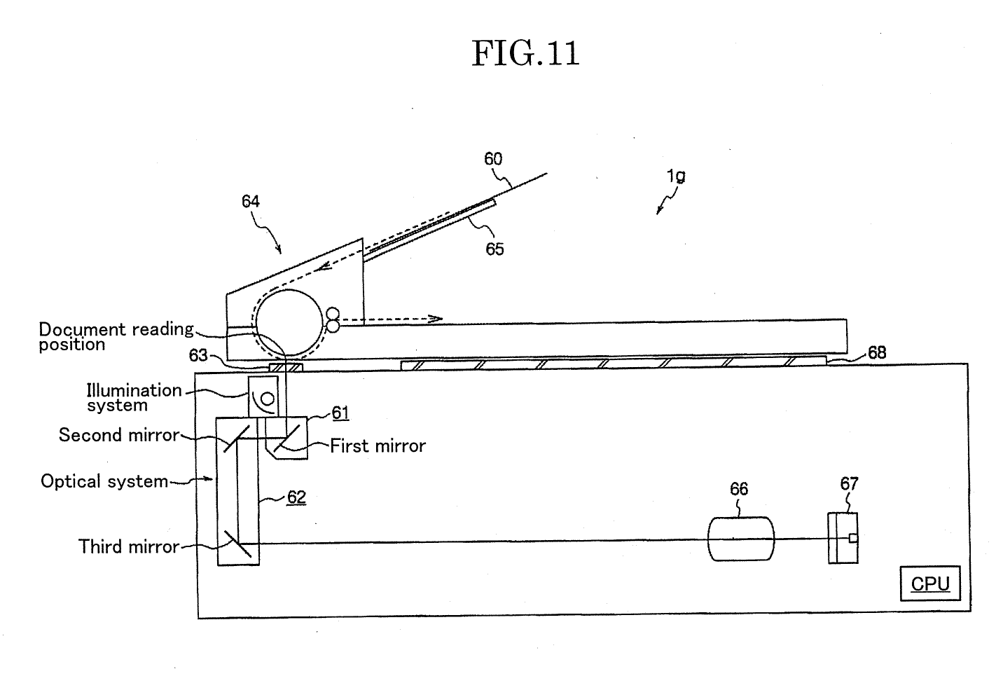

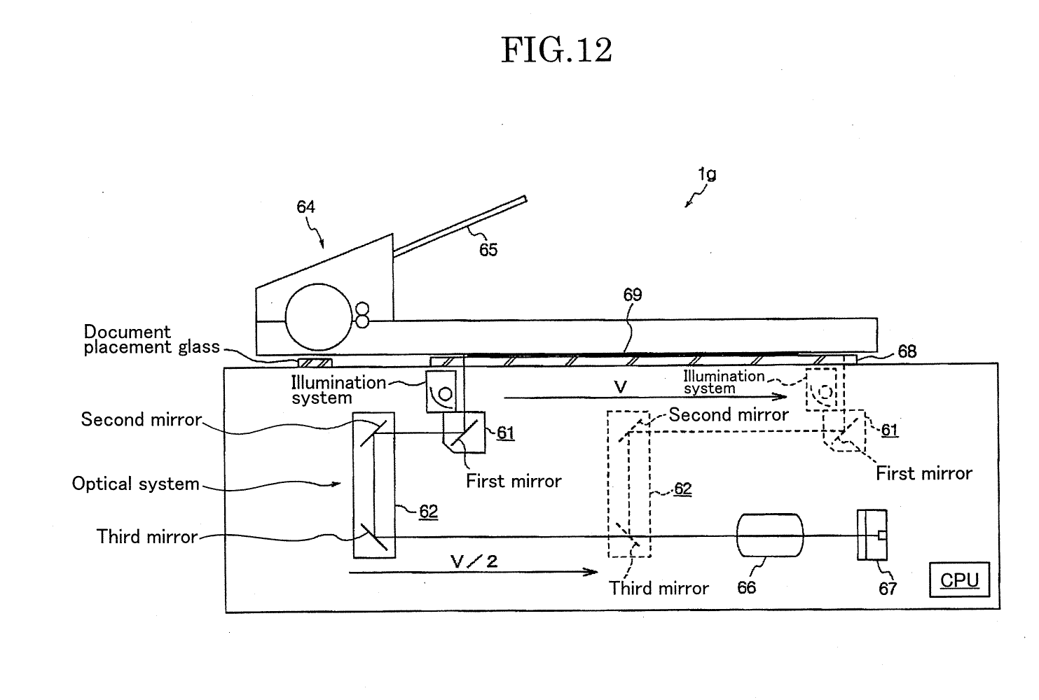

Next, an image reading apparatus according to a seventh embodiment of the present invention, which changes an object distance by varying a physical distance, will be described with reference to FIGS. 11 and 12.

In an image reading apparatus 1g illustrated in FIG. 11, a position of a first moving carriage 61 and a second moving carriage 62 for example is adjusted such that an object distance becomes optimum when a document 60 is to be read by the sheet-through type.

When the document 60 is to be read by the sheet-through type, the first moving carriage 61 and the second moving carriage 62 are arranged to positions corresponding to a document placement glass 63 being dedicated for the sheet-through type, respectively, and the document 60 is conveyed from a document tray 65 of ADF 64 to the document placement glass 63 for the sheet-through type. Thereafter, the document 60 is conveyed on the document placement glass 63 at a substantially constant speed. Information on the conveyed document 60 is read by the first moving carriage 61 and the second moving carriage 62 for example stopped at the positions corresponding to the document placement glass 63, respectively, to be imaged on a line sensor 67 with a reduction image forming lens 66.

When a document 69 is to be read by the pressure plate type, as illustrated in FIG. 12, the document 69 is set on a document placement glass 68, and thereafter, the first moving carriage 61 and the second moving carriage 62 are moved to their reading-initiation positions of the pressure plate type, respectively. At this time, the object distance is changed to be in an optimum value when the first moving carriage 61 and the second moving carriage 62 have moved to the reading-initiation positions of the pressure plate type, respectively, by varying movement speed of the first moving carriage 61 and the second moving carriage 62. Then, the first moving carriage 61 is moved to a position illustrated by a dotted line at a speed of “V”, and simultaneously, the second moving carriage 62 is moved to a position illustrated by a dotted line at a speed “V/2” half the speed of the first moving carriage 61, so as to read the entire part of the document 69.

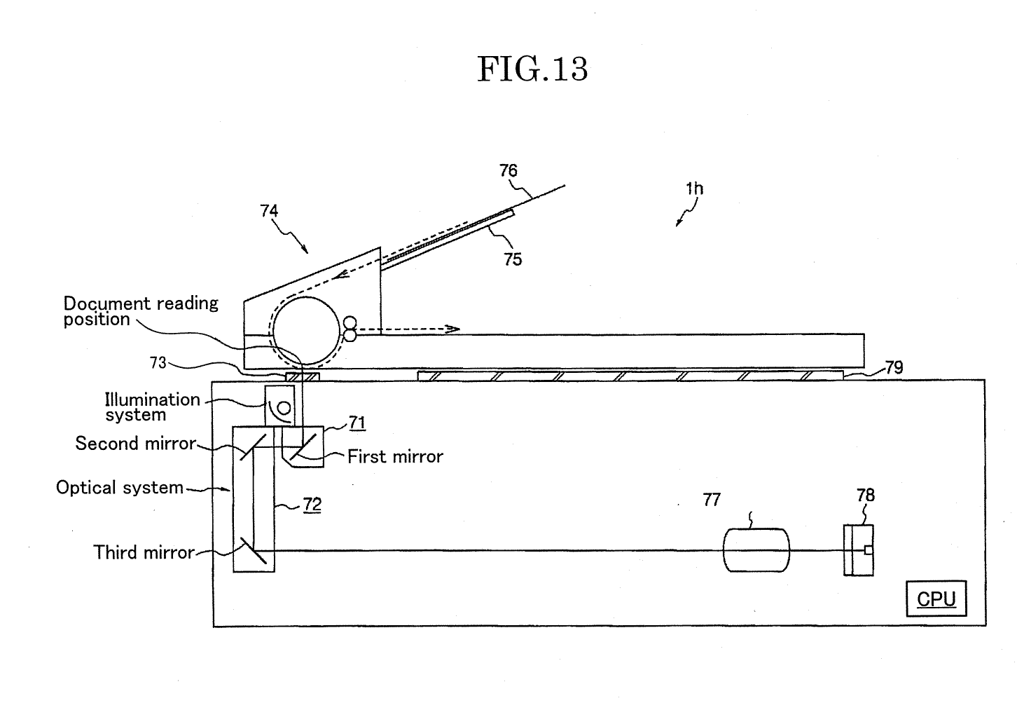

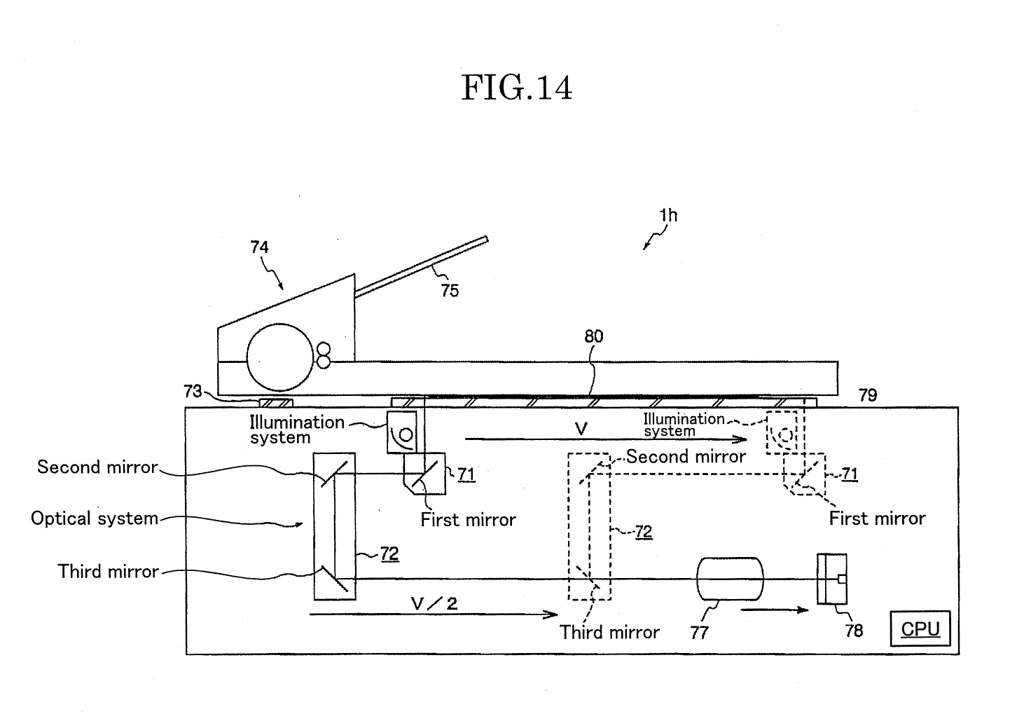

Next, an image reading apparatus according to an eighth embodiment of the present invention, which changes an object distance by varying a physical distance, will be described with reference to FIGS. 13 and 14.

In an image reading apparatus 1h illustrated in FIG. 13, a position of a first moving carriage 71 and a second moving carriage 72 for example is adjusted such that an object distance becomes optimum when a document 76 is to be read by the sheet-through type.

When the document 76 is to be read by the sheet-through type, the first moving carriage 71 and the second moving carriage 72 are arranged to positions corresponding to a document placement glass 73 being dedicated for the sheet-through type, respectively, and the document 76 is conveyed from a document tray 75 of ADF 74 to the document placement glass 73 for the sheet-through type. Thereafter, the document 76 is conveyed on the document placement glass 73 at a substantially constant speed. Information on the conveyed document 76 is read by the first moving carriage 71 and the second moving carriage 72 for example stopped at the positions corresponding to the document placement glass 73, respectively, to be imaged on a line sensor 78 with a reduction image forming lens 77.

When a document 80 is to be read by the pressure plate type, as illustrated in FIG. 14, the document 80 is set on a document placement glass 79. Thereafter, the first moving carriage 71 and the second moving carriage 72 are moved to their reading-initiation positions of the pressure plate type, respectively, and the reduction image forming lens 77 and the line sensor 78 are moved integrally such that the object distance becomes optimum. Then, the first moving carriage 71 is moved to a position illustrated by a dotted line at a speed of “V”, and simultaneously, the second moving carriage 72 is moved to a position illustrated by a dotted line at a speed “V/2” half the speed of the first moving carriage 71, so as to read the entire part of the document 80.

Note that the present eighth embodiment may be applied to and combined with other embodiments of the present invention. More specifically, operation similar to that of the image reading apparatus 1h according to the eighth embodiment described above may be carried out, for example, in the image reading apparatus 1b according to the second embodiment in which the five mirrors 20-24 are provided as illustrated in FIGS. 4 and 5, and in the image reading apparatus 1c according to the third embodiment in which the unit-magnification image forming element 36 is provided as illustrated in FIGS. 6 and 7.

For example, in each of the image reading apparatuses 1b and 1c, in a case in which the integrated optical system 27 or the optical system 38 is adjusted such that the object distance becomes optimum when the document is read with the sheet-through type and then the document is read with the pressure plate type, the position of the entire integrated optical system 27 or the optical system 38 is changed to have the object distance longer so as to read the document.

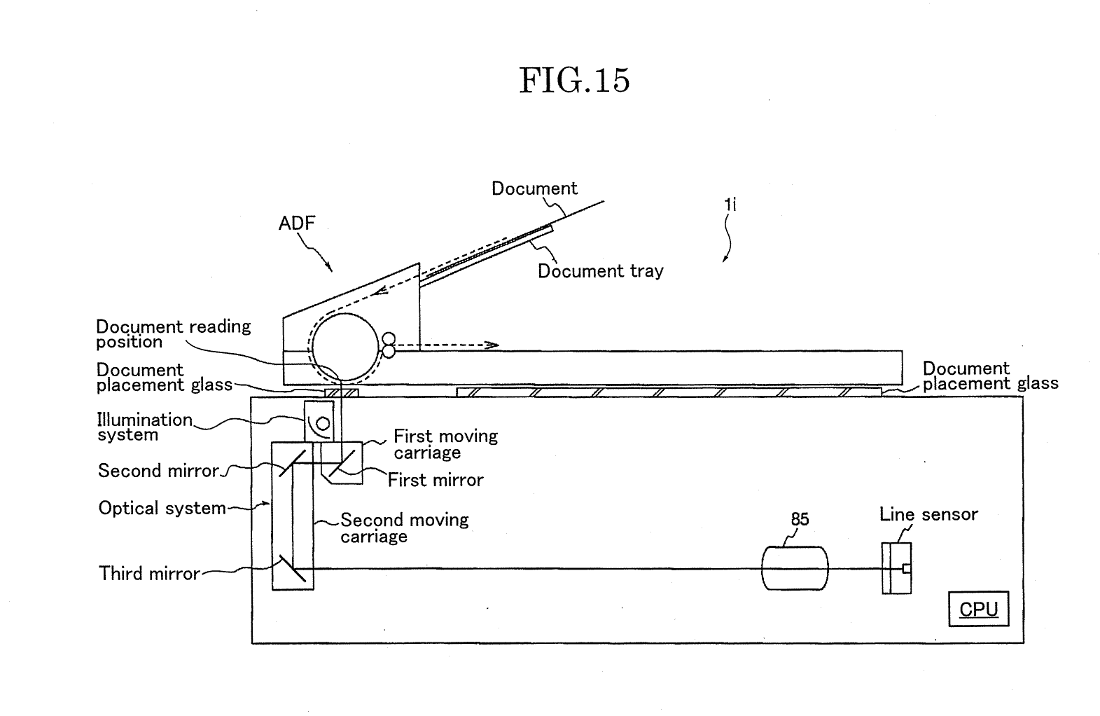

Next, an image reading apparatus according to a ninth embodiment of the present invention will be described with reference to FIG. 15.

In an image reading apparatus 1i illustrated in FIG. 15, an optical glass lens utilizing a glass material which does not contain harmful substances such as lead, arsenic and so on is utilized for all of the lenses, such as a reduction image forming lens 85.

Therefore, according to the ninth embodiment, since all of the lenses are structured by the optical glasses which are chemically stable and excluding the harmful substances such as lead, arsenic for example, recycling of materials is possible and there will be no water pollution caused by wastewater at the time of processing. In addition, resource saving and reduction of carbon dioxide for example which generates in the processing are possible. Therefore, it is possible to provide the image reading apparatus 1i which is earth-conscious.

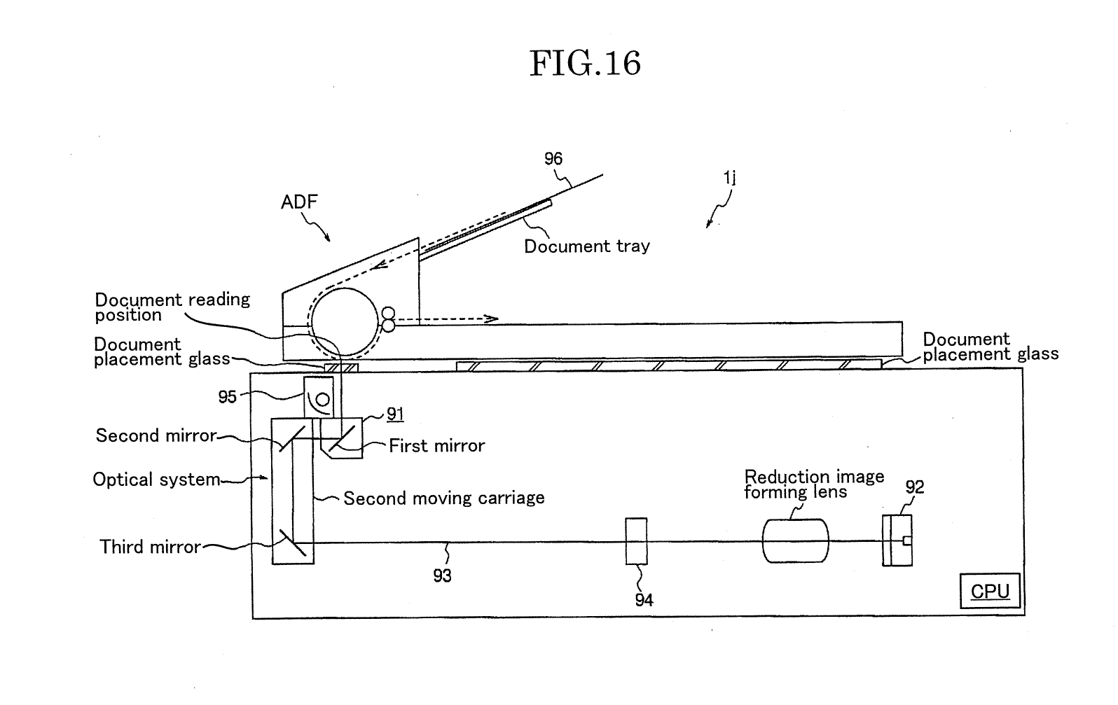

Next, an image reading apparatus according to a tenth embodiment of the present invention will be described with reference to FIG. 16.

In an image reading apparatus 1j illustrated in FIG. 16, a color separation function is added in an optical path 93 from an illustration-omitted reading lens provided in a first moving carriage 91 to a line sensor 92, so as to read a document 96 in color.

In the present embodiment, a red-green-blue filter 94, a color separation prism 94 or the like is selectively inserted into an arbitrary position in the optical path 93 as the color separation function, although it is not limited thereto.

Note that any other suitable method may be utilized other than the color separation function in which the red-green-blue filter 94, the color separation prism 94 or the like is selectively inserted into the arbitrary position in the optical path 93 described above. In one embodiment, an illumination system 95 is provided with a red light source, a green light source and a blue light source, and these light sources are subsequently lit to illuminate the document 96. In one embodiment, a so-called three-line CCD (Charge-Coupled Device), in which light-receiving elements having red color, light-receiving elements having green color and light-receiving elements having blue color are arranged in a single chip, is used as the line sensor 92, and a color image of the document 96 is imaged on a light-receiving surface of the three-line CCD to perform color separation into three primary light colors.

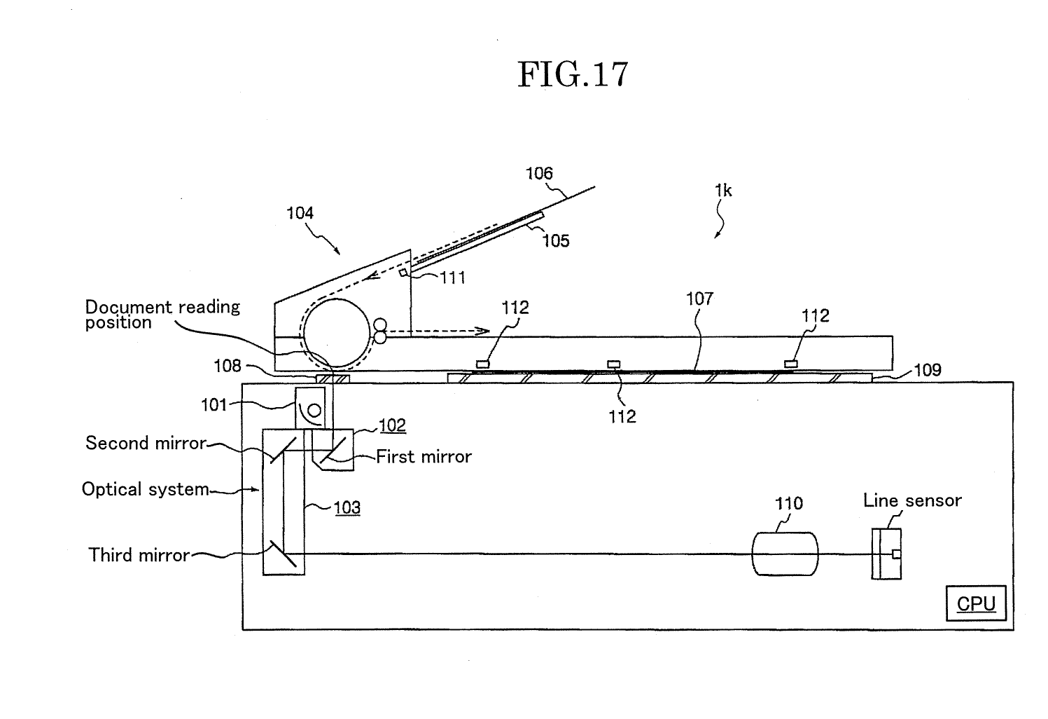

Next, an image reading apparatus according to an eleventh embodiment of the present invention will be described with reference to FIG. 17.

An image reading apparatus 1k illustrated in FIG. 17 includes the sheet-through type in which ADF 104 is operated to move a document 106 located on a document tray 105 so as to read information of the document 106 with a state that an illumination system 101, a first moving carriage 102 and a second moving carriage 103 for example are fixed, and the pressure plate type in which the illumination system 101, the first moving carriage 102 and the second moving carriage 103 for example are made to scan a document 107 so as to read information of the document 107 with a state that the document 107 is fixed.

In addition, according to the present embodiment, whether to read the document 106 with the sheet-through type or to read the document 107 with the pressure plate type is automatically detected, and a distance from a document placement surface of each document placement glass 108, 109 to a document side surface of a reduction image forming lens 110 is optimized in response to each of the reading types.

For example, the image reading apparatus 1k includes a document detection sensor 111 which detects whether or not the document 106 is set in the ADF 104 or on the document tray 105, and a document size detection sensor 112 which detects the document 107 or a size of the document 107 when the document 107 is set on the document placement glass 109. Thereby, according to the present embodiment, reading of the document 106 is carried out with the sheet-through type when the document detection sensor 111 has detected the document 106, whereas reading of the document 107 is carried out with the pressure plate type when the document size detection sensor 112 has detected the document 107 or the size of the document 107.

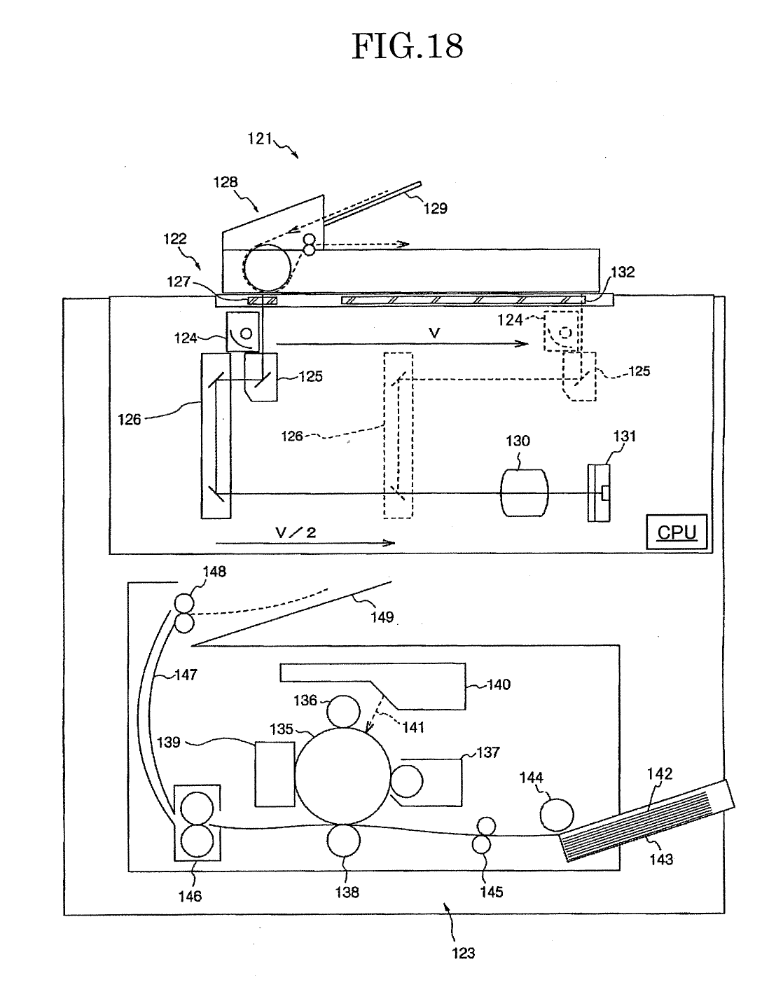

Now, an image forming apparatus according to one embodiment of the invention will be described with reference to FIG. 18.

An image forming apparatus 121 illustrated in FIG. 18 is structured by an image reading unit 122 adapted to change an object distance at the time of reading a document with the sheet-through type to an object distance at the time of reading a document with the pressure plate type and vise versa, and a laser printer unit 123 adapted to print an image read by the image reading unit 122 on a transfer paper 142 and discharge the printed transfer paper 142.

The image reading unit 122, when the document is to be read with the sheet-through type, arranges an illumination system 124, a first moving carriage 125 and a second moving carriage 126 at positions corresponding to a document placement glass 127, respectively, and conveys the document to the document placement glass 127 for the sheet-through type from a document tray 129 of ADF 128. Then, the image reading unit 122 causes the first moving carriage 125 and the second moving carriage 126 to read information of the document while conveying the document on the document placement glass 127 at a substantially constant speed, and thereafter, the read information of the document is imaged on a line sensor 131 by a reduction image forming lens 130. When the document is to be read with the pressure plate type, after the document is set on a document placement glass 132, the image reading unit 122 moves the illumination system 124, the first moving carriage 125 and the second moving carriage 126 to read information of the document while causing the object distance to be longer than that of the case in which the document is to be read with the sheet-through type, and images the read document information onto the line sensor 131 by the reduction image forming lens 130.

The laser printer unit 123 includes, as a latent image carrying body 135, a photoconductive photoreceptor formed in a cylindrical shape. A surrounding part of the latent image carrying body 135 is provided with an electrifying roller 136 as an electrifier, a developing device 137, a transferring roller 138, and a cleaning mechanism 139. In the present embodiment, a corona charger is used for the electrifier although it is not limited thereto. Moreover, an optical scanning mechanism 140 which carries out optical scanning with a laser beam 141 is provided in the laser printer unit 123, such that exposure by optical writing is performed between the electrifying roller 136 and the developing device 137.

When image formation is to be carried out, the latent image carrying body 135 as the photoconductive photoreceptor rotates in clockwise direction at a constant speed, and a surface of the latent image carrying body 135 is evenly electrified by the electrifying roller 136. Then, the latent image carrying body 135 receives the exposure by the optical writing by the laser beam 141 of the optical scanning mechanism 140, and thereby, an electrostatic latent image is formed. The formed electrostatic latent image is a so-called negative latent image in which a bright part of the image is exposed. The electrostatic latent image is reversely developed by the developing device 137 to form a toner image on the latent image carrying body 135.

A cassette 143 in which the plurality of transfer papers 142 is accommodated is provided attachably and detachably to the image forming apparatus 121. In a state in which the cassette 143 is mounted to the image forming apparatus 121 as illustrated in FIG. 18, uppermost one of the accommodated transfer papers 142 for example is fed by a paper feeding roller 144, and an end part of the fed transfer paper 142 is caught by a pair of resist rollers 145. The pair of resist rollers 145 sends the transfer paper 142 toward and between the latent image carrying body 135 and the transferring roller 138 in accordance with timing that the toner image on the latent image carrying body 135 moves to a transfer position. The sent transfer paper 142 is superimposed on the toner image on the latent image carrying body 135, and the toner image is electrostatically transferred to the transfer paper 142 by the action of the transferring roller 138. The transfer paper 142 on which the toner image is transferred is sent to a fixing device 146 to fix the toner image. Then, the transfer paper 142 passes a carrier path 147, and is discharged on a tray 149 by a pair of paper discharging rollers 148.

Therefore, according to the present embodiment, the image reading unit 122, configured to automatically change the object distance at the time when the document is read by the sheet-through type to the object distance at the time when the document is read by the pressure plate type and vise versa as described above, is used to read the image of the document, and printout of the document is carried out by the laser printer 122. Hence, cumbersome operation is unnecessary, and formation of an image based on fine image reading quality is possible, and accordingly, it is possible to obtain superior adaptability and the image having high image quality.

Accordingly, the image reading apparatus and the image forming apparatus according to the embodiments of the invention at least have the following advantageous.
(1) It is possible to obtain fine reading quality in both of the types of the pressure plate type and the sheet-through type.
(2) It is possible to obtain fine reading quality in both of the types of the pressure plate type and the sheet-through type, for example, by changing the object distance from the object distance in the pressure plate type in which information of the document is read by causing the first moving carriage and the second moving carriage to scan the document at the speed ratio of 2:1 to the object distance in the sheet-through type in which the first moving carriage and the second moving carriage are stopped to read the information of the document and vice versa.
(3) It is possible to obtain fine reading quality in both of the types of the pressure plate type and the sheet-through type, for example, by changing the object distance from the object distance in the optical system in the pressure plate type in which information on the document is read by utilizing the unit in which the plurality of mirrors, the optical system and the line sensor for example are integrated and moving the unit, to the object distance in the sheet-through type and vice versa.
(4) It is possible to obtain fine reading quality in both of the types of the pressure plate type and the sheet-through type, for example, by changing the object distance from the object distance in the optical system in the pressure plate type in which information on the document is read by utilizing the unit provided with the unit-magnification sensor and moving the unit, to the object distance in the sheet-through type and vice versa.
(5) It is possible to change the optical distance in the pressure plate type and the sheet-through type by varying at least one of the thickness and the refractive index of the document placement glasses. Accordingly, it is possible to obtain fine reading quality in both of the types of the pressure plate type and the sheet-through type without requiring a special drive system, other mechanism, or the like. In addition, a structure becomes simple and the number of components is reduced. Therefore, it is possible to reduce costs in the components and worker-hours in assembling, and to attain improvement in precision and cost-reduction.
(6) By utilizing the drive system used in the pressure plate type to vary the physical distance, it is possible to obtain fine reading quality in both of the types of the pressure plate type and the sheet-through type without requiring a special drive system, other mechanism, or the like. In addition, a structure becomes simple and the number of components is reduced. Therefore, it is possible to reduce costs in the components and worker-hours in assembling, and to attain improvement in precision and cost-reduction.
(7) The optical glass which is chemically stable and which does not include the harmful substances such as lead, arsenic and so on is used. Accordingly, recycling of materials is possible and there will be no water pollution caused by wastewater at the time of processing. Therefore, it is possible to largely contribute to global environment conservation.
(8) Since the color separator is provided, it is possible to obtain fine image reading quality in color.
(9) The sheet-through type and the pressure plate type are automatically discriminated. Accordingly, cumbersome operation of changing the reading types is not necessary, and fine image quality in both of the types of the pressure plate type and the sheet-through type is obtained with extremely easy manipulation. Hence, it is possible to largely contribute to improvement in adaptability.
(10) The image reading apparatus according to any one of the embodiments or a combination thereof is included in the image forming apparatus according to the embodiment of the invention. Hence, an image is formed based on fine image reading quality without necessity of cumbersome operation. Therefore, it is possible to obtain superior adaptability and the image of high quality.

The present application is based on and claims priority from Japanese Application Number 2006-077569, filed Mar. 20, 2006, the disclosure of which is hereby incorporated by reference herein in its entirety.

Although the present invention has been described in terms of exemplary embodiments, it is not limited thereto. It should be appreciated that variations may be made in the embodiments described by persons skilled in the art without departing from the scope of the present invention as defined by the following claims. The limitations in the claims are to be interpreted broadly based the language employed in the claims and not limited to examples described in the present specification or during the prosecution of the application, which examples are to be construed as non-exclusive. For example, in the present disclosure, the term “preferably”, “preferred” or the like is non-exclusive and means “preferably”, but not limited to. Moreover, no element and component in the present disclosure is intended to be dedicated to the public regardless of whether the element or component is explicitly recited in the following claims.

What is claimed is:

1. An image reading apparatus, comprising:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, configured to read the document while moving the document with a state in which the illumination system and the image forming optical system are fixed as a second document reading type, and configured to change an object distance from the document placement surface of the document placement glass to the image forming element of the image forming optical system when the document is to be read by the first document reading type and when the document is to be read by the second document reading type.

2. The image reading apparatus according to claim 1, wherein the controller is configured to move the document in the second document reading type by utilizing an automatic document feeder.

3. The image reading apparatus according to claim 1, wherein the image forming element structuring the image forming optical system includes an image forming lens configured to perform reduction-image formation of the image of the document.

4. The image reading apparatus according to claim 1, further comprising:
a first moving carriage having at least one reflection mirror and the illumination system; and
a second moving carriage having at least two reflection mirrors,
wherein the controller is configured to move the first moving carriage and the second moving carriage to scan the document surface of the document at a speed ratio of 2:1 in the first document reading type.

5. The image reading apparatus according to claim 1, further comprising an integrated optical system having at least one reflection mirror, the image forming element and the sensor, and wherein the controller is configured to move the integrated optical system and the illumination system in the first document reading type.

6. The image reading apparatus according to claim 1, wherein the image forming element of the image forming optical system includes an unit-magnification image forming element.

7. The image reading apparatus according to claim 1, further comprising:
a first moving carriage having at least one reflection mirror and the illumination system; and
a second moving carriage having at least two reflection mirrors,
wherein the controller is configured to vary a distance between the first moving carriage and the second moving carriage to change the object distance from the document placement surface of the document placement glass to the image forming element of the image forming optical system in the first document reading type and the second document reading type.

8. The image reading apparatus according to claim 1, wherein the image forming element structuring the image forming optical system includes an image forming lens configured to perform reduction-image formation of the image of the document, and wherein the controller is configured to vary a position of the image forming lens and the sensor integrally to change the object distance from the document placement surface of the document placement glass to the image forming element of the image forming optical system in the first document reading type and the second document reading type.

9. The image reading apparatus according to claim 1, wherein the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

10. The image reading apparatus according to claim 1, further comprising a color separation element disposed in an optical path of the image forming optical system, such that information of the document is read in color.

11. The image reading apparatus according to claim 1, wherein the controller is configured to detect whether the document is to be read by the first document reading type or the second document reading type, and configured to determine the object distance from the document placement surface of the document placement glass to the image forming element of the image forming optical system based on a result of the detection.

12. An image forming apparatus, comprising an image reading apparatus including:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, configured to read the document while moving the document with a state in which the illumination system and the image forming optical system are fixed as a second document reading type, and configured to change an object distance from the document placement surface of the document placement glass to the image forming element of the image forming optical system when the document is to be read by the first document reading type and when the document is to be read by the second document reading type.

13. An image reading apparatus, comprising:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type,
wherein the document placement glass includes a first document placement glass used in the first document reading type and having a first thickness, and a second document placement glass used in the second document reading type and having a second thickness different from the first thickness of the first document placement glass to vary an optical distance, such that an object distance from the document placement surface of the document placement glass to the image forming element of the image forming optical system when the document is to be read by the first document reading type and when the document is to be read by the second document reading type is changed.

14. An image reading apparatus, comprising:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type,
wherein the document placement glass includes a first document placement glass used in the first document reading type and having a first refractive index, and a second document placement glass used in the second document reading type and having a second refractive index different from the first refractive index of the first document placement glass to vary an optical distance, such that an object distance from the document placement surface of the document placement glass to the image forming element of the image forming optical system when the document is to be read by the first document reading type and when the document is to be read by the second document reading type is changed.

15. The image reading apparatus according to claim 13, wherein the second document placement glass further includes a refractive index different from a refractive index of the first document placement glass to change the optical distance, such that the object distance from the document placement surface of the document placement glass to the image forming element of the image forming optical system when the document is to be read by the first document reading type and when the document is to be read by the second document reading type is changed.

16. The image reading apparatus according to claim 13, wherein the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

17. The image reading apparatus according to claim 14, wherein the image forming element structuring the image forming optical system includes an image forming lens configured to perform reduction-image formation of the image of the document, and wherein the image forming lens includes a glass lens having a glass material excluding a harmful substance selected from a group comprising lead, arsenic, and a combination thereof.

18. The image reading apparatus according to claim 13, further comprising a color separation element disposed in an optical path of the image forming optical system, such that information of the document is read in color.

19. The image reading apparatus according to claim 14, further comprising a color separation element disposed in an optical path of the image forming optical system, such that information of the document is read in color.

20. The image reading apparatus according to claim 13, wherein the controller is configured to detect whether the document is to be read by the first document reading type or the second document reading type, and configured to determine the object distance from the document placement surface of the document placement glass to the image forming element of the image forming optical system based on a result of the detection.

21. The image reading apparatus according to claim 14, wherein the controller is configured to detect whether the document is to be read by the first document reading type or the second document reading type, and configured to determine the object distance from the document placement surface of the document placement glass to the image forming element of the image forming optical system based on a result of the detection.

22. An image forming apparatus, comprising an image reading apparatus including:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type,
wherein the document placement glass includes a first document placement glass used in the first document reading type and having a first thickness, and a second document placement glass used in the second document reading type and having a second thickness different from the first thickness of the first document placement glass to vary an optical distance, such that an object distance from the document placement surface of the document placement glass to the image forming element of the image forming optical system when the document is to be read by the first document reading type and when the document is to be read by the second document reading type is changed.

23. An image forming apparatus, comprising an image reading apparatus including:
a document placement glass having a document placement surface and on which a document is placed;
an illumination system configured to illuminate the document;
an image forming optical system including an image forming element and configured to image reflected light of the document illuminated by the illumination system;
a sensor configured to perform photoelectric conversion of an image of the document imaged by the image forming optical system; and
a controller configured to move the illumination system and the image forming optical system to scan a document surface of the document to read the document with a state in which the document is fixed onto the document placement glass as a first document reading type, and configured to read the document while moving the document with a state in which the illumination system and the image forming optical system are fixed as a second document reading type,
wherein the document placement glass includes a first document placement glass used in the first document reading type and having a first refractive index, and a second document placement glass used in the second document reading type and having a second refractive index different from the first refractive index of the first document placement glass to vary an optical distance, such that an object distance from the document placement surface of the document placement glass to the image forming element of the image forming optical system when the document is to be read by the first document reading type and when the document is to be read by the second document reading type is changed.

24. The image forming apparatus according to claim 22, wherein the second document placement glass further includes a refractive index different from a refractive index of the first document placement glass to vary the optical distance, such that the object distance from the document placement surface of the document placement glass to the image forming element of the image forming optical system when the document is to be read by the first document reading type and when the document is to be read by the second document reading type is changed.
